(19) United States
(12) Patent Application Publication
(10) Pub. No.: US 2016/0155582 A1
(43) Pub. Date: Jun. 2, 2016

(54) KEYBOARD AND METHOD FOR ASSEMBLING THE KEYBOARD

(71) Applicant: HON HAI PRECISION INDUSTRY CO., LTD., New Taipei (TW)

(72) Inventor: HSIN-YUAN PENG, New Taipei (TW)

(21) Appl. No.: 14/587,347

(22) Filed: Dec. 31, 2014

(30) Foreign Application Priority Data
Nov. 27, 2014 (TW) 103141113

(51) Int. Cl. H01H 13/7065; H01H 13/04; H01H 13/88

(52) U.S. Cl. CPC H01H 13/7065; H01H 13/88; H01H 13/04

(57) ABSTRACT

A keyboard includes a frame member, a support member, and a main body. The frame member includes a frame defining a number of holes, and a number of mounting pillars extending down from a bottom surface of the frame. The main body includes a circuit board defining a number of through holes, and a number of keys mounted on the circuit board and extending through the holes of the frame. The support member includes a number of mounting holes. The mounting pillars extend through the through holes and the mounting holes, and are deformed by stamping a bottom surface of the support member. The present disclosure also discloses a method of assembling the keyboard.

### FIELD

The subject matter herein generally relates to a keyboard and a method for assembling the keyboard.

### BACKGROUND

Traditional keyboards are generally assembled by a number of screws and rivets.

### BRIEF DESCRIPTION OF THE DRAWINGS

Implementations of the present technology will now be described, by way of example only, with reference to the attached figures.

FIG. 1 is an exploded, isometric view of an embodiment of a keyboard, wherein the keyboard comprises a frame member, a support member, and a main body.

FIG. 2 is an enlarged view of a circle portion II of FIG. 1.

FIG. 3 is an inverted view of FIG. 1.

FIG. 4 is an enlarged view of a circle portion IV of FIG. 3.

FIG. 5 is an enlarged view of a circle portion V of FIG. 3.

FIG. 6 is an assembled, isometric view of the keyboard of FIG. 1.

FIG. 7 is an assembled, isometric view of the keyboard of FIG. 3, wherein the keyboard is not stamped.

FIG. 8 is an enlarged view of a circle portion VIII of FIG. 7.

FIG. 9 is another view of the keyboard of FIG. 7 and stamping equipment, wherein the keyboard is stamped.

FIG. 10 is an enlarged view of a circle portion X of FIG. 9.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

The present disclosure is described in relation to a keyboard and a method for assembling the keyboard.

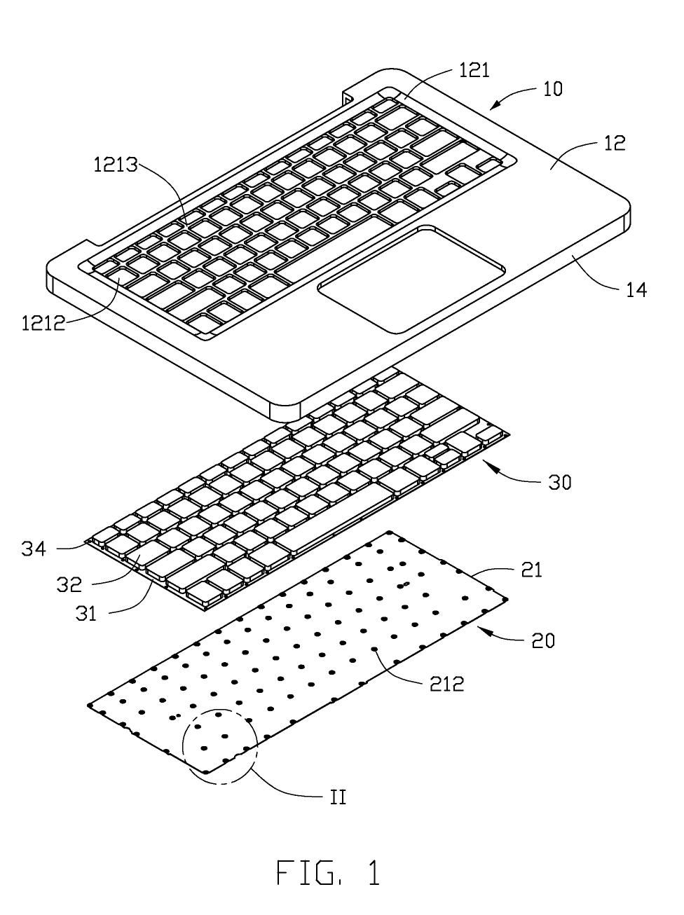

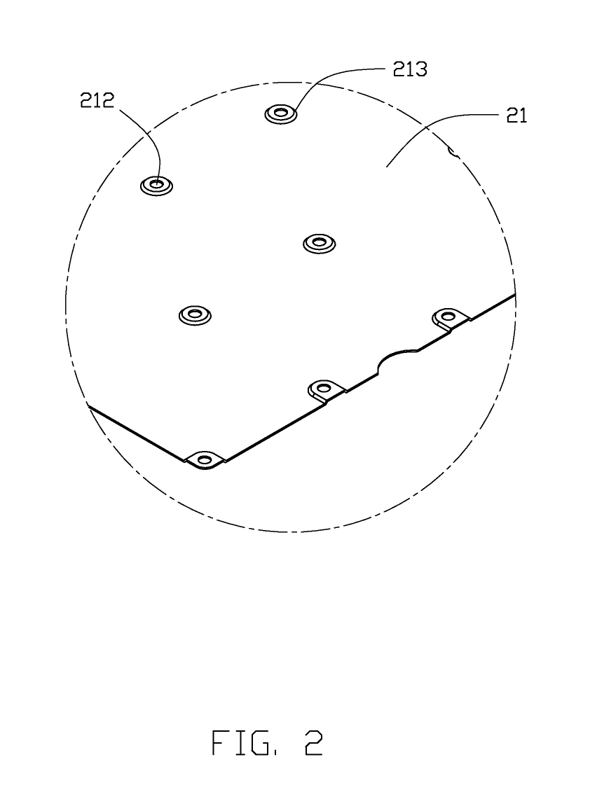

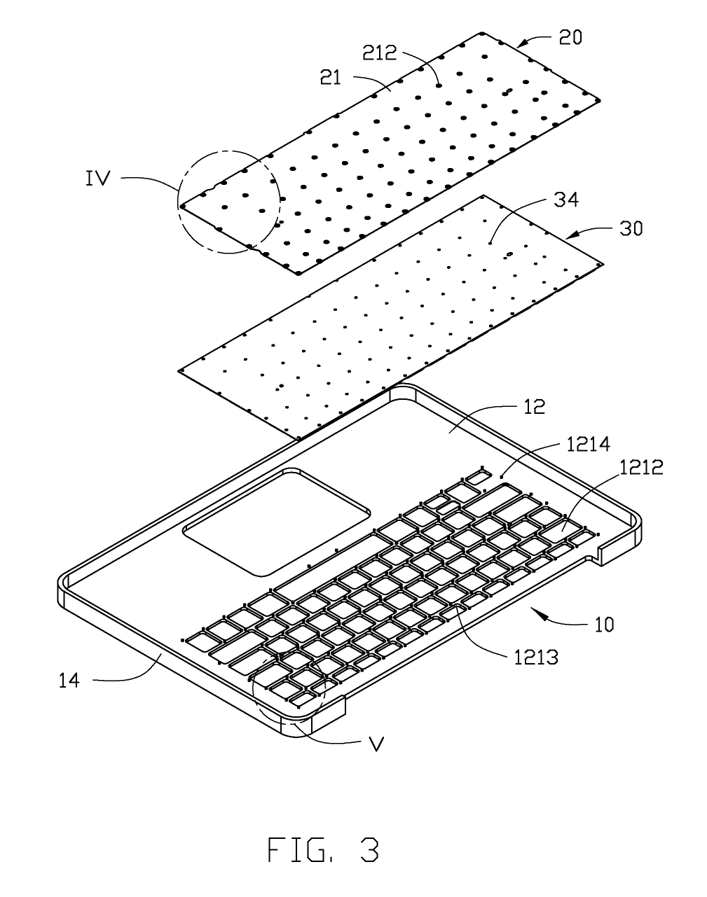

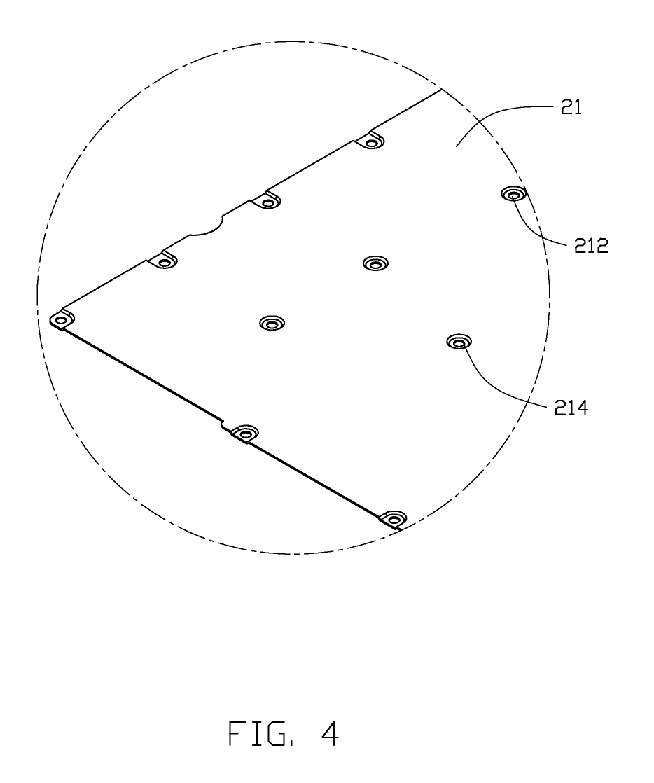

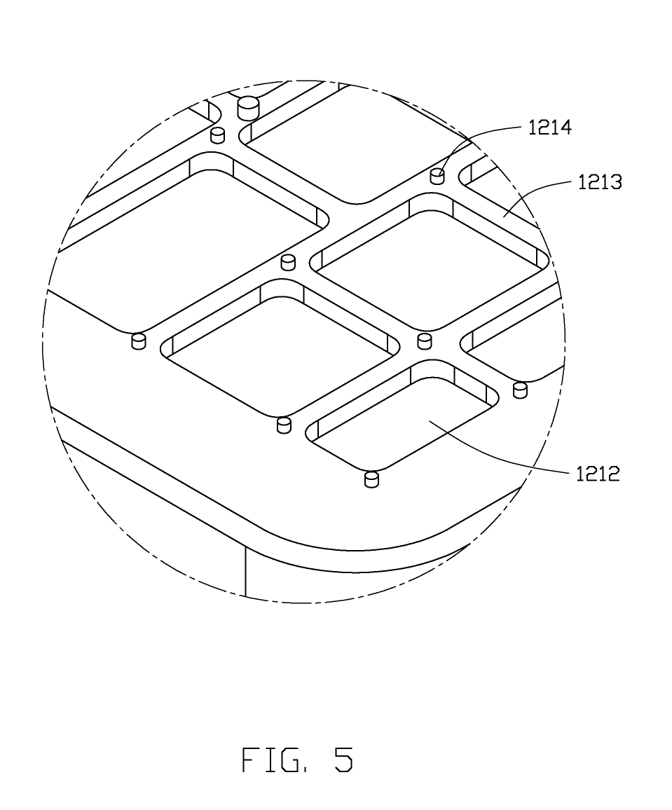

FIGS. 1 to 5 illustrate an embodiment of a keyboard. The keyboard comprises a frame member 10, a support member 20, and a main body 30 mounted between the frame member 10 and the support member 20.

The frame member 10 comprises a base plate 12 and a plurality of flanges 14 extending down from edges of the base plate 12. A front portion of the base plate 12 forms a concave keyboard area 121. The keyboard area 121 comprises a frame 1213 defining a plurality of holes 1212. A plurality of mounting pillars 1214 extend down from a bottom surface of the frame 1213, around the frame 1213 and each hole 1212. In at least one embodiment, the frame member 10 can be a top panel of a notebook keyboard and be made of metal materials.

The main body 30 comprises a circuit board 31 and a plurality of keys 32 mounted on the circuit board 31. A plurality of through holes 34 is defined in the circuit board 31 around the circuit board 31 and each key 32, corresponds to the mounting pillars 1214 of the frame member 10.

The support member 20 can be a metal board 21. The board 21 defines a plurality of mounting holes 212, corresponding to the through holes 34 of the main body 30. A recess 214 is formed on a bottom surface of the board 21 around each mounting hole 212; correspondingly, a bulge 213 protrudes upward from a top surface of the board 21 around each mounting hole 212.

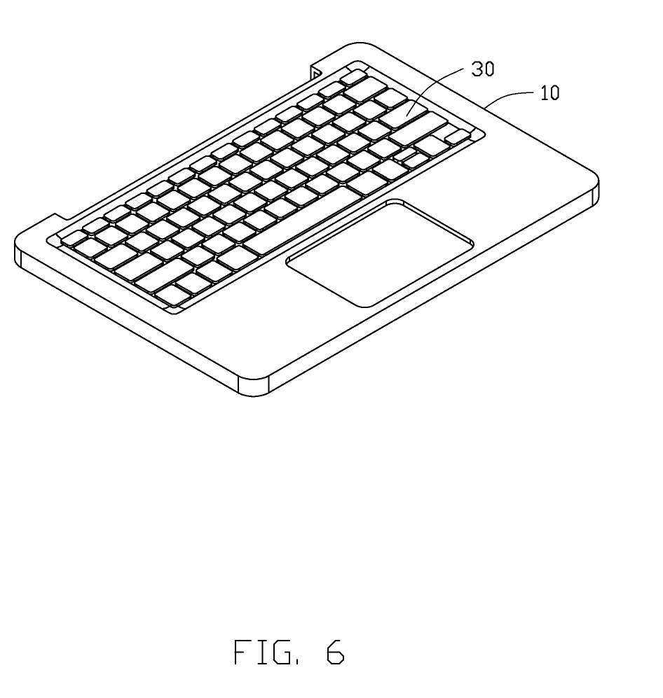

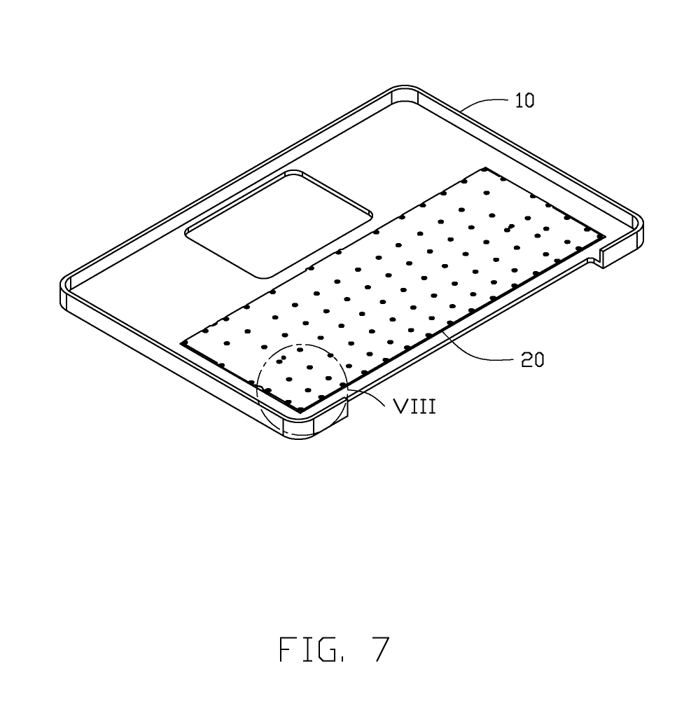

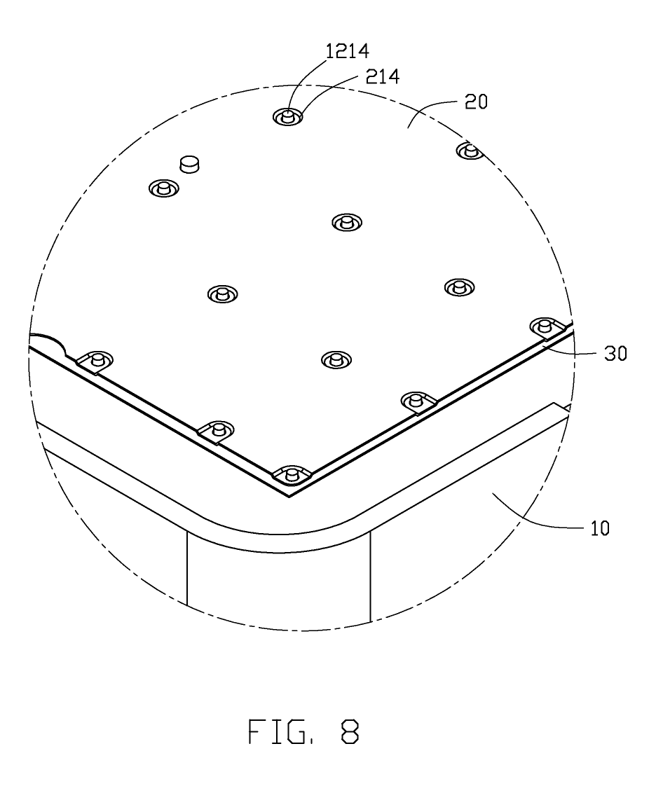

FIGS. 6 to 8 illustrate when in assembly, the main body 30 can be placed on the bulges 213 of the support member 20, with the keys 32 facing up and the through holes 34 aligned with the corresponding mounting holes 212. The frame member 10 can be placed on the main body 30. The keys 32 can extend through the corresponding holes 1212, to be exposed from the keyboard area 121 of the base plate 12. The mounting pillars 1214 of the keyboard area 121 can extend through the corresponding through holes 34 of the main body 30 and the mounting holes 212 of the support member 20. Bottom ends of the mounting pillars 1214 extend out of the bottom surface of the board 21 of the support member 20.

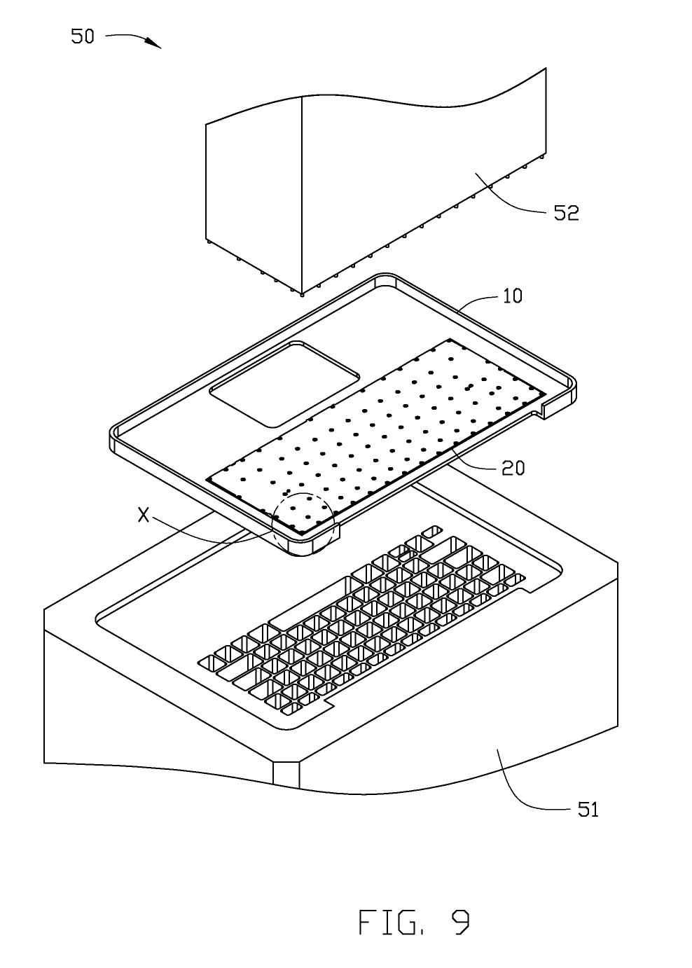

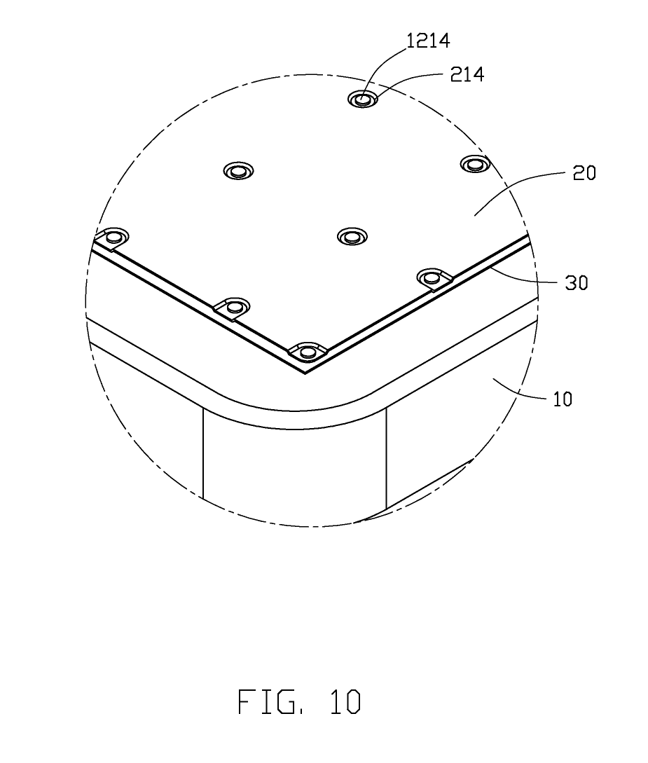

FIGS. 9 and 10 illustrate that the keyboard is stamped. The pre-assembled frame member 10, support member 20, and main body 30 can be inverted and placed into stamping equipment 50, with the frame member 10 on the bottom. A lower die 51 of the stamping equipment 50 supports the frame 1213 of the keyboard area 121 avoiding the keys 32. An upper die 52 of the stamping equipment 50 moves down to stamp the mounting pillars 1214, making the bottom ends of the mounting pillars 1214 be deformed to engage with the corresponding recesses 214 of the board 21. The keyboard is completely assembled. The assembled keyboard can be fetched from the stamping equipment 50 and be further assembled to a notebook.

In a second embodiment, the pre-assembled keyboard can be supported on a platform, with the frame member 10 on the top. An upper die abuts against the frame 1213 of the keyboard area 121 avoiding the keys 32. A lower die moves up and stamps the mounting pillars 1214, making the bottom ends of the mounting pillars 1214 deform to engage with the corresponding recesses 214 of the board 21.

In a third embodiment, the frame member 10 can be a top panel of a traditional keyboard, and the support member 20 can be a bottom panel of the traditional keyboard.

In other embodiments, a diameter of each through hole 34 can be greater than a diameter of each bulge 213. In assembly, the bulges 213 can be received in the corresponding through holes 34.

The embodiments shown and described above are only examples. Many details are well known by those in the art therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A keyboard comprising:
a frame member comprising a frame defining a plurality of holes, and a plurality of mounting pillars extending down from a bottom surface of the frame;
a support member comprising a plurality of mounting holes; and
a main body comprising a circuit board defining a plurality of through holes, and a plurality of keys mounted on the circuit board;
wherein the keys of the main body extend through the holes of the frame, the mounting pillars extend through the through holes and the mounting holes, and are deformed by stamping to engage with a bottom surface of the support member.

2. The keyboard of claim 1, wherein the frame of the frame member is made of metal material.

3. The keyboard of claim 2, wherein the support member is a board, a recess is formed on a bottom surface of the board around each mounting hole, bottom ends of the mounting pillars deformed by stamping are engaged in the corresponding recesses.

4. The keyboard of claim 3, wherein a top surface of the board forms a plurality of bulges respectively around the mounting holes, corresponding to the recesses, the main body are supported on the bulges.

5. The keyboard of claim 3, wherein a top surface of the board forms a plurality of bulges respectively around the mounting holes, corresponding to the recesses, the bulges are received in the corresponding through holes of the main body.

6. The keyboard of claim 2, wherein the keyboard is used in a notebook, the frame member is a top panel of the keyboard of the notebook.

7. The keyboard of claim 1, wherein the frame member comprises a base plate and a plurality of flanges extending down from edges of the base plate, the base plate forms a concave keyboard area, the frame is located in the keyboard area.

8. The keyboard of claim 1, wherein the mounting pillars are respectively arranged around the holes of the frame, and the through holes are respectively arranged around the keys.

9. The keyboard of claim 1, wherein the frame member is a top panel of the keyboard, the support member is a bottom panel of the keyboard.

10. A method for assembling the keyboard of claim 1, comprising:
placing the main body onto the support member, with the through holes of the main body aligning with the mounting holes of the support member;
placing the frame member onto the main body, with the keys of the main body extending through the holes of the frame member, and the mounting pillars of the frame member extending through the through holes of the main body and the mounting holes of the support member; and
placing the pre-assembled frame member, support member, and main body into a stamping equipment, a first die of the stamping equipment abutting against the frame avoiding the keys, a second die of the stamping equipment moving toward the support member and stamping the mounting pillars, free ends of the mounting pillars being deformed to engage with the bottom surface of the support member.

11. The method of claim 10, wherein the frame of the frame member is made of metal material.

12. The method of claim 11, wherein the support member is a board, a recess is formed on a bottom surface of the board around each mounting hole, bottom ends of the mounting pillars deformed by stamping are engaged in the corresponding recesses.

13. The method of claim 12, wherein a top surface of the board forms a plurality of bulges respectively around the mounting holes, corresponding to the recesses, the main body are supported on the bulges.

14. The method of claim 12, wherein a top surface of the board forms a plurality of bulges respectively around the mounting holes, corresponding to the recesses, the bulges are received in the corresponding through holes of the main body.

15. The method of claim 10, wherein the mounting pillars are respectively arranged around the holes of the frame, and the through holes are respectively arranged around the keys.
